(19) United States
(12) Patent Application Publication
(10) Pub. No.: US 2003/0031303 A1
(43) Pub. Date: Feb. 13, 2003

(54) Answering machine with caller-specific call management

(76) Inventors: Simon Lee, Sai Kung (HK); Terence Fong, Ma On Shan Centre (HK)

Correspondence Address: Matthew J. Spark, SKERVEN MORRILL, MacPHERSON LLP, Suite 700, 25 Metro Drive, San Jose, CA, 95110-1349, US

(21) Appl. No.: 09/924,385

(22) Filed: Aug. 8, 2001

(51) Int. Cl. H04M 1/64; H04M 1/56

(52) U.S. Cl. 379/67.1; 379/142.17

(57) ABSTRACT

An answering machine includes memory for storing voice messages and caller identification records. A control system receives input from a user and causes a display system to display caller identification information from a selected caller identification record in response to input from the user. The control system also causes a presentation system to present a voice message associated with the selected caller identification record.

### TECHNICAL FIELD OF THE INVENTION

The present invention relates to telephone answering machines, and in particular to an answering machine with caller-specific call-management.

### BACKGROUND OF THE INVENTION

Answering machines which also receive and display Caller ID information are known. However, conventional answering machines typically provide the same treatment for all incoming calls, regardless of the identity of the caller. That is, the same outgoing message is played for all callers, and all messages are stored in sequential order in the answering machine's memory. Moreover, the playback of message and display of Caller ID information typically are not correlated in any meaningful way other than the Caller ID information of a caller being displayed when an answering machine plays back a recorded message from the caller.

### SUMMARY OF THE INVENTION

Therefore, a need has arisen for an answering machine that addresses the disadvantages and deficiencies of the prior art. In particular, a need has arisen for an answering machine with caller-specific call-management.

Accordingly, a novel answering machine is disclosed. In one embodiment, the answering machine includes a first memory for storing voice messages and a second memory for storing caller identification records. A display system can display caller identification information from a caller identification record stored in the second memory. A presentation system can present a voice message stored in the first memory in a perceptible manner to a user. A user input system can receive input from the user. A control system receives input from the user and causes the display system to display caller identification information from a selected caller identification record in response to the input from the user. The control system also causes the presentation system to present a voice message associated with the selected caller identification record.

### BRIEF DESCRIPTION OF THE DRAWINGS

For a more complete understanding of the present invention and for further features and advantages, reference is now made to the following description taken in conjunction with the accompanying drawings, in which:

FIG. 1 is a top view of an answering machine designed in accordance with the present invention;

FIG. 2 is a block diagram of the answering machine;

FIG. 3 is a diagram of a voice memory record stored by the answering machine;

FIG. 4 is a diagram of a caller identification record stored by the answering machine; and

FIG. 5 is a diagram of a Very Important Person (VIP) record stored by the answering machine.

### DETAILED DESCRIPTION OF THE INVENTION

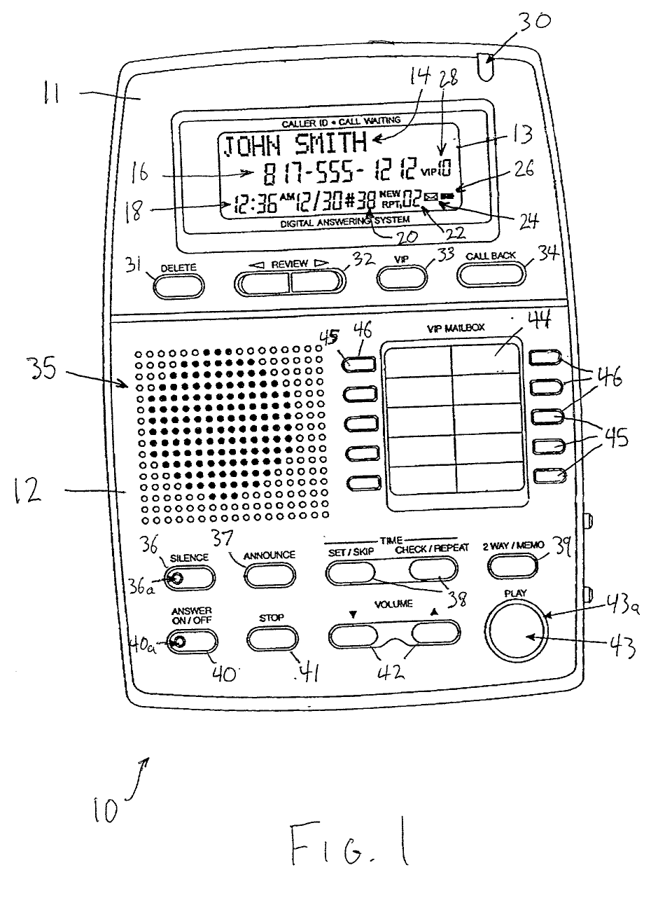

The preferred embodiments of the present invention and their advantages are best understood by referring to FIGS. 1 through 5 of the drawings. Like numerals are used for like and corresponding parts of the various drawings.

Referring to FIG. 1, a top view of an answering machine 10 designed in accordance with the present invention is shown. Answering machine 10 is capable of receiving and storing caller identification information (such as Caller ID information). Answering machine 10 allows the user to designate some callers as VIPs. These VIPs (and any messages they leave) receive special treatment by answering machine 10, as described below. Answering machine 10 is capable of storing an incoming message associated with caller identification information and allows the user to retrieve a stored incoming message.

The face of answering machine 10 includes an upper portion 11 primarily associated with caller identification display and control and a lower portion 12 primarily associated with voice message display and control. This functional distinction between upper and lower portions 11 and 12, while true on a general level, is not exact, and there is some overlap of and interaction between the functions performed in the two portions, as described below.

Upper portion 11 includes a display screen 13, which may be, for example, a liquid crystal display (LCD) screen. Display screen 13 is one of several displays or indicators on answering machine 10. The fields displayed by display screen 13 primarily relate to caller identification.

Thus, there is a name field 14, which displays the name of a caller. A telephone number field 16 displays a caller's telephone number. A time/date field 18 displays either the current time and date (in idle mode) or the time and date of the telephone call currently displayed on display screen 13.

A call number field 20 provides an index number of the currently displayed telephone call. Answering machine 10 may have a storage capacity of, for example, 99 telephone calls. That is, caller identification information may be stored for up to 99 telephone calls. Call number field 20 therefore displays an index number (from one to 99) for each call.

A new call field 22 indicates the number of new calls received since caller identification information was last reviewed by the user. A voice mail indicator 24 may be used to indicate a voice mail message stored by the telephone service provider (separate from the voice messages stored by answering machine 10). A battery indicator 26 indicates the level of charge carried by the battery installed in answering machine 10, or may simply indicate whether the battery is low.

Finally, a VIP indicator field 28 indicates whether the currently displayed telephone call was from a designated VIP. If the caller was a designated VIP, the field indicates by index number which VIP called. The designation of VIPs by the user is described below.

Upper portion 11 also includes general mailbox message indicator light 30, which may be an LED (light emitting diode). Message indicator light 30 blinks on and off when a new (unplayed) message has been stored in the general mailbox by answering machine 10. Message indicator light 30 stays on (without blinking) when there are no new messages, but at least one old (previously played) message is stored in the general mailbox. Message indicator light 30 is off when there are no messages stored in the general mailbox.

Like many conventional Caller ID boxes, answering machine 10 includes buttons for manipulating the stored list of telephone calls. A delete button 31 allows the user to delete the currently displayed call from memory. Review buttons 32 allow the user to navigate forward and backward through the list of calls to display a call of interest. Call back button 34, when pressed, causes answering machine 10 to automatically dial the telephone number for the currently displayed call.

Answering machine 10 also includes a VIP button 33. Each VIP is assigned to a particular VIP mailbox. If the currently displayed call is from a non-VIP (as indicated by VIP indicator field 28), pressing VIP button 33 will cause the caller to be added to the list of VIPs. After that, one of VIP mailbox buttons 45 must then be pressed to assign the new VIP to a particular VIP mailbox. If the currently displayed call is from a VIP, pressing VIP button 33 and then delete button 31 will cause the caller to be deleted from the list of VIPs. Answering machine 10 automatically saves an incoming VIP message into a specified location, or VIP mailbox, for that particular VIP. In order to review which mailbox is associated with a particular VIP, the user presses VIP button 33 and then review button 32 to display the list of mailboxes.

In lower portion 12, answering machine 10 includes a speaker 35 for audible message playback. A silence button 36 allows the user to select silence mode. When reviewing caller identification information using review buttons 32, a message left by a caller is automatically played when the corresponding call is displayed on display screen 13, unless silence mode is selected. Silence button 36 acts as a toggle button, allowing the user to turn silence mode on and off. An associated LED 36a is lit when silence mode is turned on.

An announce button 37 allows the user to record or play back an outgoing message or announcement. For example, to record a VIP announcement, press announce button 37, hold down VIP mailbox button 45 and speak into the microphone. To playback an announcement, press announce button 37, causing an LED light underneath the mailbox button of any mailbox with a recorded outgoing message to flash. After that, pressing any one of the mailbox buttons causes the outgoing message corresponding to that mailbox to play. For example, after pressing announce button 37, pressing the play button 43 will play a general outgoing message while pressing one of the VIP buttons 45 will play the outgoing message associated with that VIP.

Time buttons 38 allow the user to set and replay the current time as kept by answering machine 10. A memo button 39 allows the user to record a personal memo message on answering machine 10. This message is treated like any other incoming message left by a caller on answering machine 10, except that no caller identification information is associated with a message left in this fashion.

An answer on/off button 40 allows the user to select whether answering machine 10 will answer incoming calls. An associated LED 40a indicates whether answering machine 10 is in answer mode or not. To turn on answering machine 10, answer on/off button 40 is pressed causing LED 40a to illuminate and answering machine 10 to emit a single beeping sound.

A stop button 41 may be used to stop playback of a message. Volume buttons 42 allow the user to increase or decrease the volume of message playback on speaker 35.

A play button 43 allows the user to initiate playback of messages stored in the general mailbox by answering machine 10. An associated LED 43a surrounding play button 43 is lit when messages are being played back. When LED 43a flashes, this is an indication that there are new messages in the general mailbox. After playing the messages, LED 43a maintains a continuous illumination to indicate the existence of old messages if the messages are not erased.

A name panel 44 provides a place for up to ten (10) VIP names to be listed. These may be the names of individuals associated with individual VIP mailboxes. Adjacent to each of the 10 name sections in name panel 44 is a VIP playback button 45. Pressing a VIP playback button 45 causes answering machine 10 to play back any messages stored in the associated VIP mailbox.

Each VIP playback button 45 has an associated VIP mailbox message indicator light 46 surrounding the playback button. Each message indicator light 46, which may be an LED, blinks on and off when a new (unplayed) message has been stored in the VIP mailbox associated with the message indicator light 46. Message indicator light 46 stays on (without blinking) when there are no new messages, but at least one old (previously played) message is stored in the VIP mailbox. Message indicator light 46 is off when there are no messages stored in the VIP mailbox.

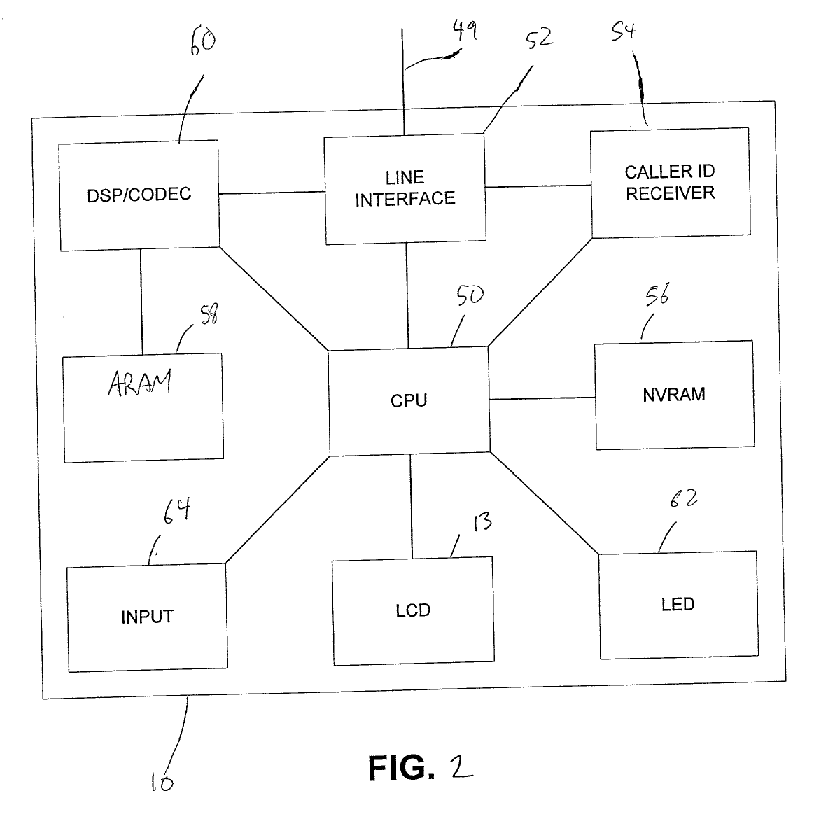

Referring to FIG. 2, a block diagram of answering machine 10 is shown. A central processing unit (CPU) 50 performs control functions within answering machine 10. The various control functions performed by CPU 50 are described below.

A line interface 52 provides a physical and electrical interface to a telephone line 49. Line interface 52 electrically connects to the tip and ring conductors of telephone line 49 and provides communication between telephone line 49 and other blocks of answering machine 10. Line interface 52, which may be a conventional line interface, is capable of conveying “off-hook” and “on-hook” states on telephone line 49, detecting ringing current on telephone line 49, and transmitting and receiving voice signals over telephone line 49. The functions of line interface 52 are controlled by CPU 50.

A Caller ID receiver 54 detects Caller ID information received on telephone line 49. Caller ID information is conventionally transmitted on telephone line 49 between the first and second rings. Thus, when a ringing current is detected by line interface 52 on telephone line 49, Caller ID receiver 54 monitors the telephone line signals provided by line interface 52. Caller ID receiver 54 then decodes the Caller ID information and provides the decoded Caller ID information to CPU 50. The Caller ID information may be stored in a Caller ID memory 56 and displayed on display screen 13 as described above. In one embodiment, Caller ID memory 56 may be implemented as a nonvolatile memory.

A voice memory 58 is used to store voice messages in digital format. In one embodiment, voice memory 58 may be implemented in a memory, such as a conventional audio RAM (ARAM), which is separate from Caller ID memory 56. Alternatively, voice memory 58 and Caller ID memory 56 can be implemented in respective portions of the same memory facility. A coder/decoder (codec) and digital signal processor (DSP) 60 digitizes and encodes voice signals received on telephone line 49 for storage in voice memory 58. DSP/codec 60 is an ASIC with a built-in programmable microprocessor. DSP/codec 60 also decodes voice messages for transmission as voice signals on telephone line 49. The storage and retrieval of messages in voice memory 58 by DSP/codec 60, which may be accomplished using conventional techniques, is controlled by CPU 50.

When one or more incoming voice messages are stored in voice memory 58, an LED display system 62 notifies the user of the existence of the messages. LED display system may include general mailbox message indicator light 43a and VIP mailbox message indicator lights 46 described above.

Playback of voice messages, display of Caller ID information and other control functions are manually controlled by the user by means of input system 64, which may include the various control buttons shown in FIG. 1 and described above. Input system 64 provides control signals to CPU 50, which in turn controls the other components of answering machine 10.

Like other answering machines, answering machine 10 responds to an incoming telephone call by going off-hook to answer the call after a specified number of rings (as determined by CPU 50). An outgoing message previously stored in voice memory 58 is played to the caller, after which the caller is given the opportunity to record an incoming message in voice memory 58. This incoming message may later be played back by the user. Like some conventional Caller ID devices, answering machine 10 may store and display Caller ID information associated with incoming calls, regardless of whether the caller leaves a message on answering machine 10.

Unlike previous answering machines, answering machine 10 provides the ability to correlate incoming messages with Caller ID information stored in non-volatile memory 56, and to treat incoming calls differently depending on the Caller ID information associated with each incoming call. Information stored on both nonvolatile memory 56 and voice memory 58 may be used to accomplish these functions.

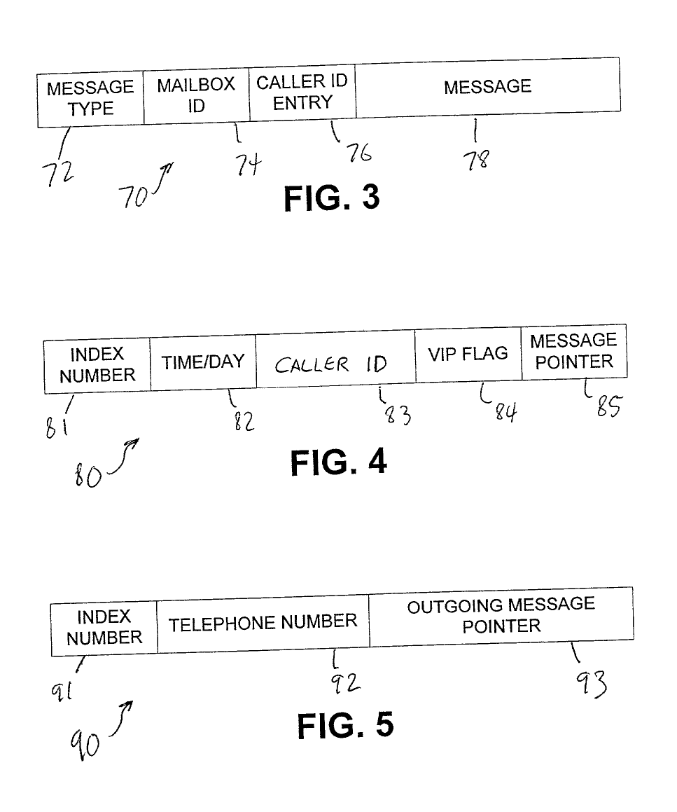

Referring to FIG. 3, the components of a voice memory record 70 are shown. Voice memory record 70 represents an entry stored in voice memory 58. Each voice memory record 70 includes a voice message and header information associated with the message. Four types of messages are stored in voice memory 58: a general outgoing message, VIP outgoing messages, general incoming messages and VIP incoming messages. Voice memory record 70 includes a message type field 72, which indicates which of the four types of messages is stored in record 70.

Voice memory record 70 also includes a mailbox identification field 74, which contains an identification of the mailbox with which the message is associated. In the case of general incoming messages and the general outgoing message, mailbox identification field 74 identifies the general mailbox. In the case of VIP incoming and outgoing messages, mailbox identification field 74 identifies the VIP mailbox (by index number) with which the message is associated.

Voice memory record 70 also includes a caller identification record field 76, which indicates (again by index number) which caller identification record the message is associated with. The storage of caller identification information is described below. Voice memory record 70 also includes a message field 78, which stores audio data comprising the incoming or outgoing voice message.

Referring to FIG. 4, the components of a caller identification record 80 are shown. Caller identification entries such as record 80 may be stored in non-volatile memory 56 as previously described.

Caller identification record 80 includes an index number field 81. The index number stored in field 81 indicates the position of caller identification record 80 in the sequence of caller identification records stored in non-volatile memory 56.

Caller identification record 80 also includes a time/day field 82, which stores the time and day of the incoming call, and a caller identification field 83, which stores the information identifying the caller, such as the caller's telephone number. If the caller left a message, message pointer field 85 contains a pointer to the voice memory record 70 associated with caller identification record 80.

Referring to FIG. 5, the components of a VIP record 90 are shown. VIP entries such as record 90 may be stored in non-volatile memory 56.

VIP record 90 includes an index number field 91 storing an index number associated with the VIP in question. A telephone number field 92 stores the VIP's telephone number. An outgoing message pointer 93 stores a pointer to a VIP outgoing message if the user has generated one for the VIP in question, or to the general outgoing message if an individual outgoing message has not been generated for the VIP.

It will be appreciated that the record structures and controls described above allow answering machine 10 to correlate incoming messages with Caller ID information stored in non-volatile memory 56, and to treat incoming calls differently depending on the Caller ID information associated with each incoming call. Specifically, a VIP may be assigned an individual mailbox for storing incoming messages from the VIP. A specific VIP voice message may also be created for each VIP. A user may create an outgoing message for a particular VIP by pressing announce button 37. A prompt appears on display screen 13 requesting the user to choose which particular VIP the user wishes to record an outgoing message for by pressing VIP button 45 associated with that VIP. Moreover, as described above, messages may be accessed based on caller identification information displayed on display screen 13.

Answering machine 10 is capable of being set to function and display messages in any one of a number of languages a user may select including, without limitation, English or Spanish.

Although the present invention and its advantages have been described in detail, it should be understood that various changes, substitutions, and alterations can be made therein without departing from the spirit and scope of the invention as defined by the appended claims.

I claim:

1. An answering machine comprising:
a first memory operable to store voice messages;
a second memory operable to store caller identification records;
a display system operable to display caller identification information from a caller identification record stored in the second memory;
a presentation system operable to present a voice message stored in the first memory in a perceptible manner to a user;
a user input system operable to receive input from the user;
a control system in communication with the display system, the memory, the presentation system and the user input system, the control system being operable to receive the input from the user, the control system being further operable to cause the display system to display caller identification information from a selected caller identification record in response to the input from the user, the control system being further operable to cause the presentation system to present a voice message associated with the selected caller identification record.

2. The answering machine of claim 1, wherein the user input system comprises:
a caller identification input system; and
a message playback input system;
wherein the control system is operable to receive user input from the message playback input system, the control system being further operable to cause the presentation system to present a voice message in response to the user input from the message playback input system, the control system being further operable to display caller identification information associated with the voice message in response to the user input from the message playback input system.

3. The answering machine of claim 1, wherein the first memory comprises an audio RAM.

4. The answering machine of claim 1, wherein the second memory comprises a non-volatile memory.

5. The answering machine of claim 1, wherein the user input system and the display system are further operable to allow the user to classify callers into at least two categories.

6. The answering machine of claim 5, wherein the user input system and the display system are further operable to allow the user to establish a separate voice mailbox for each caller which is classified into one of the at least two categories.

7. The answering machine of claim 1, wherein
a general mailbox is provided for all callers in a first category;
a respective VIP mailbox is provided for each caller in a second category; and
the general mailbox and each respective VIP mailbox are implemented, at least in part, by the first memory.

8. The answering machine of claim 1, wherein the control system is further operable to store any voice messages from a caller in the first category into the general mailbox, and the control system is further operable to story any voice messages from a caller in the second category into a respective VIP mailbox.

9. A method for processing calls, comprising:
receiving an indication of a call on a telephone line;
receiving caller identification data associated with the call over the telephone line;
determining from the caller identification data whether the call is from a specially designated caller;
presenting an outgoing message on the telephone line;
receiving an incoming message over the telephone line;
storing the incoming message;
if the call is from a specially designated caller, storing the incoming message with an identification of the specially designated caller.

10. The method of claim 9, wherein presenting the outgoing message comprises:
if the call is from a specially designated caller, presenting an outgoing message designated for the specially designated caller; and
if the call is not from a specially designated caller, presenting a general outgoing message.

11. The method of claim 9, further comprising
receiving input from a user requesting playback of messages from the specially designated caller; and
presenting to the user the stored incoming message in response to the input from the user.

12. The method of claim 9, further comprising storing the caller identification data.

13. The method of claim 12, further comprising:
receiving input from a user requesting display of the caller identification data; and
displaying the caller identification data in response to the input from the user;
presenting to the user the stored incoming message in conjunction with displaying the caller identification data.

14. The method of claim 9, further comprising storing the incoming message with an indication of the caller identification data.

15. The method of claim 14, further comprising:
receiving input from a user requesting playback of the stored incoming message; and
presenting to the user the stored incoming message in response to the input from the user; and
displaying the caller identification data in conjunction with presenting the stored incoming message to the user.
